(19) United States
(12) Patent Application Publication
(10) Pub. No.: US 2008/0102871 A1
(43) Pub. Date: May 1, 2008

(54) Communication Integration Unit

(76) Inventors: John V. Watt, Victoria (CA); Gary Bartlett, Victoria (CA); Larry A. Cole, Victoria (CA)

Correspondence Address: J. GORDON THOMSON, P.O. BOX 8865, VICTORIA, BC, V8V 3Z1, US

(21) Appl. No.: 11/871,838

(22) Filed: Oct. 12, 2007

Related U.S. Application Data
(60) Provisional application No. 60/863,514, filed on Oct. 30, 2006.

(51) Int. Cl. H04Q 7/20; H04B 7/00

(52) U.S. Cl. 455/518

(57) ABSTRACT

A communication integration unit and method of use for forming a communications network for transmitting and receiving information between non-compatible first and second communications apparatus. The network comprises at least a first and a second member. The method comprises the steps of: providing each member with a communication integration unit for integrating and controlling the non-compatible communications apparatus. The integration unit comprises a first communications apparatus for communicating within the network. The method includes selecting a second communication apparatus for communicating outside of the network and connecting it to the integration unit. The integration unit then adapts the second communication apparatus for communication with the network.

### CROSS REFERENCE TO OTHER APPLICATIONS

This application claims the benefit of priority from U.S. Provisional Patent Application 60/863,514 filed in the United States Patent and Trademark Office on Oct. 30, 2006 for an invention entitled “TeamComms™ Communications Integrations Unit” describing the same invention.

### FIELD OF THE INVENTION

This invention relates to communications equipment and more particularly a communication integration unit for communication between multiple parties using multiple and different communication devices.

### BACKGROUND OF THE INVENTION

Previously it has been difficult to integrate communication between parties that are using multiple and different communications devices. For example, in some emergency situations, one set of parties might be communicating using RF systems and another set of parties might be communicating using cell phones. This invention service to integrate communication between such parties so that they may exchange data using otherwise non-compatible systems. To the best of our knowledge such a system has not been proposed previously.

### SUMMARY OF THE INVENTION

In one example of the invention there is provided a method of forming a communications network for transmitting and receiving information comprising at least a first and a second member. The method comprises the first step of providing each of the first and second members with a communication integration unit for integrating and controlling a plurality of communications means. The unit comprises an integral first communications means for communicating within the network. The next step in the method is to select at least a second communication means for communicating outside of the network. In the next step, the second communication means is connected to the unit. Then the second communication means is adapted for communicating within the network through the unit.

In another example of the invention the method step of selecting at least a second communication means comprises the step of selecting a communication device operating over the electromagnetic spectrum.

In yet another example of the invention any one of the network members is tasked to operate the communication device for transmitting and receiving information. The tasked member independently controls the operation of the device through the unit and determines when other team members are permitted to transmit and receive information outside of the network.

In one example of the invention the method further comprises the steps of: (1) adding additional communication means to the network for communicating within the network. The additional communications means operate over the electromagnetic spectrum; (2) connecting one of the additional communications means to the unit; (3) adapting one of the additional communication means for communicating outside of the network so that the one of the additional communication means is added to communications within the network and permits communication outside of the network, the result being that the first and second members of the network are capable of communicating within the network and outside of the network using the additional communications means connected to the unit.

The invention also provides for a communication integration unit for creating a wireless communications network between a team of members. Each member of the team is provided with the unit. The unit comprises a first communications means embedded within the unit thereby permitting communications within the team of members. A second communications means is operatively connected to the unit for communications outside of the team.

In another example of the invention the communication means is radio-frequency means permitting full duplex communications.

In yet another example of the invention communication within the team occurs without requiring members to depress any switch or control device and is thus “hands-free” in operation.

In one example of the invention the second communication means comprises at least one communications device using the electromagnetic spectrum for communication purposes.

In another example of the invention, the unit further comprises selection means permitting each team member to select between first communication means, second communication means and combined first and second communications means. This selection means determines the members signal contribution to the wireless communication network. The selection means may further permit the selection between a receive mode and a transmit mode on each of the first and second communications means, thus controlling member and team access to communications means.

In an example of the invention the communication integration unit further comprises connection means for connecting the second communications means. The connection means may be wire or wireless.

In one example of the invention the communications network is secured by security means such as encryption means.

In a further example of the invention the communication integration unit further includes a headset and microphone for two-way communication that may be connected by wire or wireless means. The microphone may include muting means.

In one example of the invention the unit and communications devices are adapted for mobility by mobility means such as an article of clothing worn by a team member and adapted to carry the unit and communications devices. A helmet may also be included for carrying the headset and microphone. The article of clothing may be a belt or a vest.

### BRIEF DESCRIPTION OF THE DRAWINGS

FIG. 1 is a pictorial representation of one example of the invention.

FIG. 2 is a pictorial representation of a communication integration unit of one example of the invention mounted on a User.

FIG. 3. is schematic diagram of one example of a communication integration unit.

FIG. 4 is a schematic diagram showing interoperability of multiple groups.

### DESCRIPTION

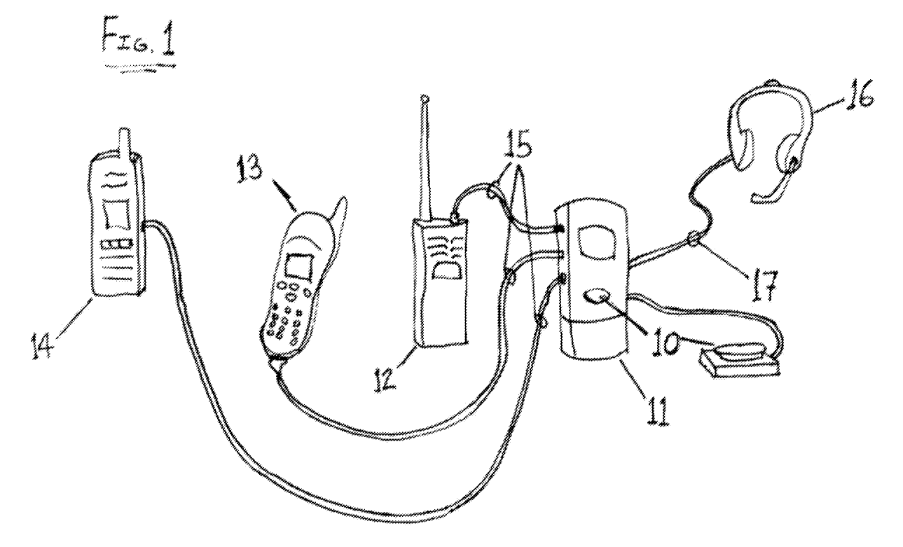

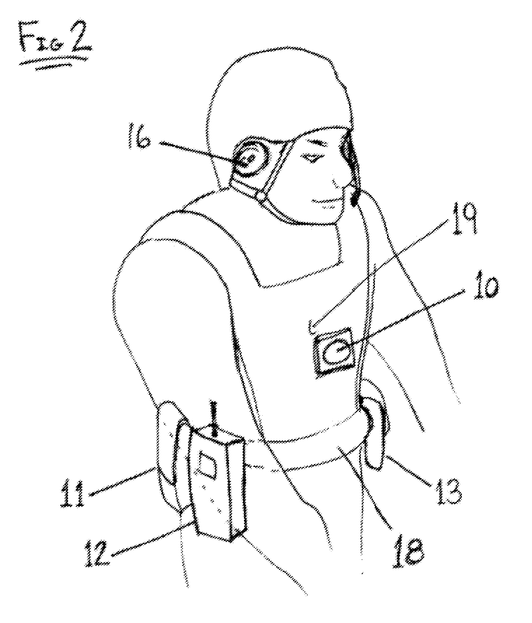

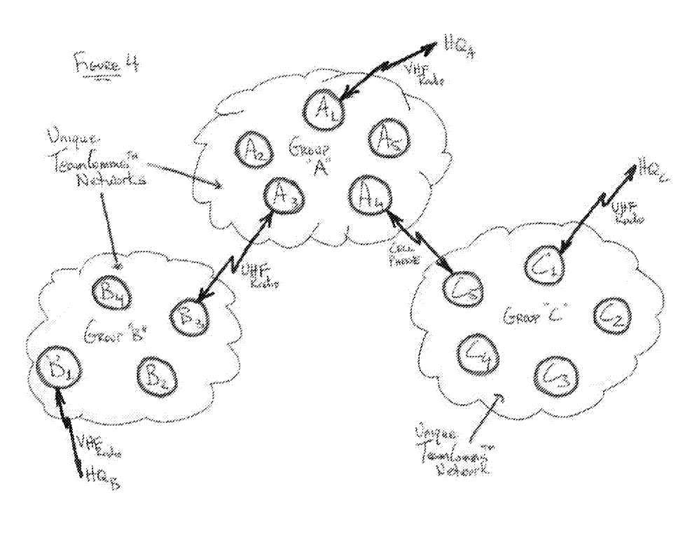

FIG. 1 is a pictorial representation of one example of the invention, namely, the communication integration unit (“hereinafter the Integrator”) as it would be connected in use. The Integrator 11 is shown connected to auxiliary electronic communication devices which are typically used by individuals engaging in mobile communications. These include UHF/VHF radios 12, cellular phones 13, and other mobile devices 14 such as PDA's, satellite phones, etc. These devices are connected by electrical cables/connectors 15 such as are generally available on the market and appropriate for each specific device so as to facilitate two-way electronic communication. The Integrator 11 is connected to a headset 16 by an appropriate connector which enables two-way electronic communication. An additional control switch 10, generally referred to as a “Push to Talk” or PTT switch, is also shown to assist the operator in controlling the engagement of communication devices 11, 12, 13 and 14 (or more) as discussed later in FIG. 3

A person skilled in the art would understand that the Integrator can accommodate external communication devices (shown as radios 12, cell phones 13, PDA's and Satellite radios 14, or more) through wireless means. Similarly, the connection of the headset 16 and the PTT switch could also be effected wirelessly. This wireless means would be of a type and nature that is generally available in the marketplace (example: Bluetooth™, ZigBee™ and others).

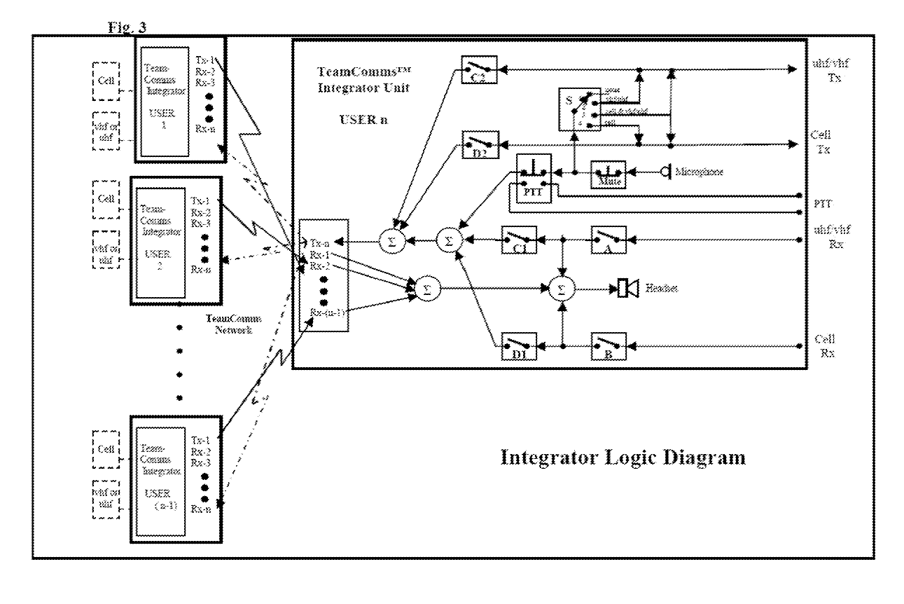

FIG. 2, shows a pictorial representation of how the Integrator would typically be mounted on a User. A “User” is defined as any individual who is equipped with an Integrator unit. In this figure the User 19 is shown wearing the Integrator 11 on a hip belt 18, which also serves as a mounting location for a UHF/VHF Radio 12 and a cellular phone 13. Note that this view depicts a system with devices that are wirelessly connected and thus no device interconnections are shown. The headset 16 is shown mounted on the User's head and the PTT switch 10 is shown in a chest-mounted position (which may, at the User's discretion be placed at any location deemed appropriate by the User). A feature of the Integrator is its capability to accommodate multiple types and styles of auxiliary external communications devices, and multiple types and styles of headset communications devices.

A Network is formed by a grouping (typically but not exclusively a task-focused team) of Users who are equipped with Integrators interconnected through radio-frequency means. Users join, or are included in, a specific Network on a controlled basis through application of generally available electronic access control/password techniques. Once a User is accepted in the Network all voice communications between Users within the Network is full-duplex (allowing simultaneous send and receive ability) and does not require physical intervention (such as depressing a PTT) to permit communication. Voice communications within the Network is kept exclusive to the specific Network through the use of generally available encryption/decryption techniques.

In its simplest configuration, the Integrator 11 is connected only to the headset 16 and without connection to auxiliary external communications devices (12, 13, 14 or more) provide Intercom mode communications ability to the User. Thus when two or more Users are within the Network they are able to communicate freely and confidentially without further intervention. Functionality is also provided for the User to mute their personal headset 16 microphone in situations where inter-personal voice communication is not to be shared with the Network.

### Operation

FIG. 3 below presents a schematic representation of the Integrator connected to a UHF/VHF radio and a cellular phone for illustrative purposes. In this figure, User 1, User 2 and additional users up to User (n−1), (where n is determined by software and/or hardware settings) are depicted with each User's Integrator connected to a cell phone and a UHF/VHF radio. Each User participates in the Network for intercom-style communication. The radio and cell phone used by each individual may be set to any channel number, station, phone number or frequency as defined by the Users' requirements (or alternately, as determined by the requirements of the task-focused team engaged in the Network).

In FIG. 3 a series of control switches identified as A, B, C1, C2, C3, D1, D2, D3 and S are provided for the individual user to select the mode of communication desired. These switches may be selected and activated through voice or physical means (or, any combination of these means) such as is effective for the User.

Table 1 provides a summary of the switch settings used for each of the operational cases described next. In the first example of operation, identified as Case I, where the User (identified as User n) has turned off all switches (shown as condition 0), and switch S is in position 1 (“none”), the User is able to communicate in a full-duplex fashion with all other Users in the Network and any auxiliary communications devices connected to the Integrator are disconnected from the Network. The individual is able to use any auxiliary communication device(s) but they are completely isolated from the Network.

In Case II, the User wishes to monitor the connected UHF/VHF radio (which is set to a pre-selected channel/frequency as desired) without wanting the option to transmit to this device, switch A is in the ON (condition 1) position, switch S is in position 1 (“none”), all other switches are OFF. In this case the User can listen to voice transmissions received by this radio but can not send voice transmissions. As well, the voice transmissions received by the User are not shared with the Network (which remains in intercom mode).

In Case III, the User wishes to send a voice transmission over the UHF/VHF radio. The User adjusts switch A to the ON (condition 1) position, switch S to position 2 (“UHF/VHF”) and all other switches are OFF. User then depresses the PTT switch to send a transmission over the UHF/VHF radio in half-duplex mode. After completing the voice transmission, and by releasing the PTT switch, the User is able to continue receiving transmissions from the UHF/VHF radio. In this instance, the transmissions sent and received by the User are not shared with the network (which remains in intercom mode).

In Case IV, the User wishes to share the transmissions sent and received over the UHF/VHF radio with the Network. The User adjusts switch A to the ON (condition 1) position, switch C1 C2 and C3 (which may be the same switch) to the ON position (condition 1) and switch S to position 2 (“UHF/VHF”), all other switches are OFF. This allows the User and all other members of the Network to listen to the communications received by User n on the User's uniquely connected UHF/VHF radio and as well to hear all communications transmitted by User n over the same device.

In Case V, the User wishes to monitor the connected cellular phone (which is separately dialed and connected to an external party) without wanting to transmit to this device. Switch A is moved to the OFF (condition 0) position, switch B is moved to the ON (condition 1) position, and switch S is moved to position 1 (“none”) (all other switches are moved to the OFF (condition 0) position). This allows the User to listen to voice transmissions received by this cellular phone but does not allow the User to send voice transmissions. As well, the voice transmissions received by the individual are not shared with the Network (which remains in intercom mode).

In Case VI, the User wishes to send a voice transmission over the connected cellular phone. The User moves Switch A to the OFF (condition 0) position, switch B is moved to the ON (condition 1) position, and switch S is moved to position 4 (“cell”) (all other switches are moved to the OFF (condition 0) position) and then begins communication over the cellular phone in a normal fashion. In this instance, the transmissions sent and received by the User are not shared with the Network (which remains in intercom mode).

In Case VII, the User wishes to share the transmissions sent and received over the cellular phone with the Network. The User moves Switch A to the OFF (condition 0) position, switch B is moved to the ON (condition 1) position, switch D1 D2 and D3 (which may be the same switch) to the ON position (condition 1) and switch S is moved to position 4 (“cell”) (all other switches are moved to the OFF (condition 0) position). This allows the individual and all other members of the Network to listen to the communications received by the User on their uniquely connected cellular phone and as well to hear all communications transmitted by the User over the same device. Members of the Network are thus permitted to participate in the cellular phone conversation without further intervention by the User, and the eternal party is able to fully participate in Network conversation.

In case VIII, the User wishes to monitor both the connected UHF/VHF radio (which is set to a pre-selected channel/frequency as desired) as well as the connected cellular phone (which is separately dialed and connected to an external party) without needing the option to transmit to these devices. The user moves switch A and switch B to the ON (condition 1) position and switch S is moved to position 1 (“none”) (all other switches are moved to the OFF (condition 0) position). This allows the individual to listen to transmissions received by the UHF/VHF radio and by the cellular phone but does not allow the User to send voice transmissions over either device. As well, the transmissions received by the User are not shared with the Network (which remains in intercom mode).

In Case IX, the User wishes to send a voice transmission over the cellular phone while continuing to monitor both the UHF/VHF radio and the cellular phone. The User moves switch A and switch B to the ON (condition 1) position and switch S to position 4 (“cell”) (all other switches are moved to the OFF (condition 0) position) and then begins voice communication over the cellular phone in a typical fashion. In this instance, the transmissions sent and received by the individual are not shared with the Network (which remains in intercom mode).

In Case X, the User wishes to send a simultaneous transmission over the connected cellular phone and the connected UHF/VHF radio. The User moves switch A and switch B to the ON (condition 1) position and switch S to position 3 (“cell & UHF/VHF”) (all other switches are moved to the OFF (condition 0) position) and then depresses the PTT switch to send a voice transmission over the UHF/VHF radio in half-duplex mode. For the cellular phone in this case, all conversation is transmitted regardless of the position of the PTT switch. In this instance, the voice transmissions sent and received by the individual are not shared with the Network (which remains in intercom mode).

In Case XI, the User wishes to share the transmissions sent and received over the cellular phone and the UHF/VHF radio with the Network. The User moves switch A and switch B to the ON (condition 1) position, switch D1 D2 and D3 (which may be the same switch) and switch C1 C2 and C3 (which may be the same switch) to the ON position (condition 1) and switch S to position 3 (“cell & UHF/VHF”). This allows the User and all other members of the network to listen to the communications received by the User on their uniquely connected cellular phone and UHF/VHF radio and as well to hear all communications transmitted by the User over the same devices.

From the forgoing operational cases it is thus demonstrated that in a task-focused team grouping of Users where each user is equipped with an Integrator, and through the appropriate selection of auxiliary external communication devices by the Users within the task-focused team, and through the knowledgeable manipulation of Integrator control switches by each User, it is possible to achieve communications inside the Network which fully (or selectively) integrates each and every auxiliary communications device. This allows communications device interoperability within the group while not impeding the mobility of the User.

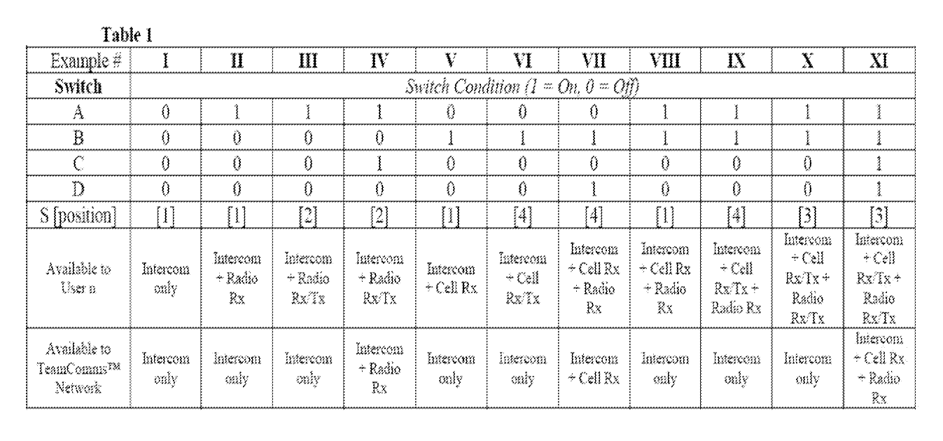

FIG. 4 demonstrates this concept of interoperability with a pictorial representation of three distinct task-focused team groupings, denoted Group “A” (comprised of five Users), Group “B” (comprised of four Users) and Group “C” (comprised of five Users). Each of these Groups has established a Network which is unique to that particular Group, but has also designated specific group members to maintain voice communications with parties external to their unique Network. This picture shows that User A1 is in communication with Group “A” Headquarters using VHF Radio, User A3 is in communication with User B3 (of Group “B”) by UHF Radio and User A4 is in contact with User C5 (of Group “C”) by cellular phone. Using the Network connection functionality described previously, the three distinctly different Groups (which may in reality be agencies such as Fire, Police, Rescue, etc.) are able communicate inter-operably while in the field without undue restriction caused by the various types and formats of voice communication devices and equipment deployed. The unique communications devices can be selectively monitored and introduced to a specific Network as necessary during field operations.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A method of forming a communications network for transmitting and receiving information, said network comprising at least a first and a second member, said method comprising the steps of: providing each of said at least first and second members with a communication integration unit for integrating and controlling a plurality of communications means, said unit comprising an integral first communications means for communicating within the network; selecting at least a second communication means for communicating outside of the network; connecting said at least second communication means to the unit; and, adapting the second communication means for communicating within the network through the unit.

2. The method of claim 1 wherein the step of selecting at least a second communication means comprises the step of selecting a device operating over the electromagnetic spectrum.

3. The method of claim 2 wherein any one of the network members is tasked to operate said device for transmitting and receiving information.

4. The method of claim 3 wherein said member independently controls the operation of the device through the unit and wherein the member determines when other team members are permitted to transmit and receive information outside of the network.

5. The method of claim 4 further comprising the steps of adding additional communication means to the network for communicating within the network wherein said additional communications means operate over the electromagnetic spectrum; connecting one of the additional communications means to the unit; adapting said one of the additional communication means for communicating outside of the network so that the one of the additional communication means is added to communications within the network and permits communication outside of the network, the result being that the at least first and second members of the network are capable of communicating within the network and outside of the network using the additional communications means connected to the unit.

6. A communication integration unit for creating a wireless communications network between a team of members, wherein each member of said team is provided with one of said units, and wherein the unit comprises a first communications means embedded within the unit thereby permitting communications within the team of members, and further wherein a second communications means is operatively connected to the unit for communications outside of the team.

7. The unit of claim 6 wherein first communication means is radio-frequency means permitting full duplex communications and wherein communication within the team occurs without requiring members to depress any switch or control device and is thus “hands-free” in operation.

8. The unit of claim 7 wherein said second communication means comprises at least one communications device using the electromagnetic spectrum for communication purposes.

9. The unit of claim 8 further comprising selection means permitting each team member to select between first communication means, second communication means and combined first and second communications means, said selection determining the members signal contribution to the wireless communication network.

10. The unit of claim 9 wherein said selection means further permits the selection between a receive mode and a transmit mode on each of the first and second communications means, thus controlling member and team access to communications means.

11. The unit of claim 10 further comprising connection means for connecting the second communications means to the unit, wherein said connection means is wire.

12. The unit of claim 11 wherein said connection means is wireless.

13. The unit of claims 12 wherein said communications network is secured by security means comprising encryption means.

14. The unit of claim 13 wherein the unit further includes a headset and microphone for two-way communication connected to the unit by wire means.

15. The unit of claim 14 wherein the headset and microphone are connected to the unit by wireless means.

16. The unit of claim 15 wherein the microphone includes muting means.

17. The unit of claim 16 wherein the unit and communications devices are adapted for mobility by mobility means comprising an article of clothing worn by a team member and adapted to carry the unit and communications devices.

18. The unit of claim 17 further including a helmet adapted to carry the headset and microphone.

19. The apparatus of claim 18 wherein said article of clothing is a belt.

20. The apparatus of claim 19 wherein said article of clothing is a vest.
